(19) United States
(12) Patent Application Publication
(10) Pub. No.: US 2012/0166522 A1
(43) Pub. Date: Jun. 28, 2012

(54) SUPPORTING INTELLIGENT USER INTERFACE INTERACTIONS

(75) Inventors: Matthew Bret MacLaurin, Woodinville, WA (US); George Moore, Covington, WA (US); Oscar E. Murillo, Redmond, WA (US)

(73) Assignee: MICROSOFT CORPORATION, Redmond, WA (US)

(21) Appl. No.: 12/978,661

(22) Filed: Dec. 27, 2010

(51) Int. Cl. G06F 15/16

(52) U.S. Cl. 709/203

(57) ABSTRACT

Concepts and technologies are described herein for supporting intelligent user interface interactions. Commands accepted by applications can be published or determined. Before or during access of the application, the commands can be presented at clients to indicate commands available for interfacing with the application. The commands can be presented with information indicating how the user interface and/or input device of the client may be used to execute the available commands. Input received from the client can be compared to the available commands to determine if the input matches an available command. Contextual data relating to the client, preferences, and/or other data also can be retrieved and analyzed to determine the intent of the client. The intent can be used to identify an intended command and to modify the input to match the intended command. The modified input can be transmitted to the application.

### BACKGROUND

In some instances, applications prescribe how the application reacts to user input or commands. In particular, applications may specify types of input recognized by the applications, as well as actions taken in response to acceptable types of input received by the application. The types of input recognized by the applications, as well as actions taken in response to the input, can be tailored based upon the device targeted for installation of the application, among other considerations.

Because input mechanisms and other aspects of devices can vary, application developers may release multiple versions of the same application, wherein the versions of the application are tailored to particular devices based upon device capabilities, command formats, and the like. Web applications, on the other hand, are tailored for execution on any device capable of accessing the Internet or other network. Thus, web applications typically are designed to provide a consistent experience across varied devices.

In addition to increasing numbers of web applications available for access, various new input devices and/or mechanisms have been developed over time. Some of these input devices are not supported by web applications and/or do not allow users to access the web applications due to limitations of the hardware and/or software of the devices. Thus, functionality of some web applications may be unusable on some devices.

It is with respect to these and other considerations that the disclosure made herein is presented.

### SUMMARY

Concepts and technologies are described herein for supporting intelligent user interface (“UI”) interactions. In accordance with the concepts and technologies disclosed herein, applications are configured to publish commands and/or command formats that are recognizable by the applications, or to be analyzed by other devices, nodes, or other entities to determine this information. During access of the application, the available commands can be presented at a client to inform a user of the commands available for interfacing with the application. The commands can be presented with information indicating how the user interface and/or input device of the client may be used to execute the available commands. When input is received from the client, the input can be compared to the available commands to determine if the input matches an available command. If so, the command can be implemented. If not, contextual data relating to the client, preferences, and/or other data can be retrieved and analyzed to determine the intent of the client in submitting the input. The intent can be used to identify an intended command and to modify the input to match the intended command. The modified input is transmitted to the application, and application execution can continue, if desired.

According to one aspect, a server computer hosts or executes an application. The server computer also can host command data describing commands and command formats recognized by the application. The server computer is in communication with an interface manager. The interface manager executes an overlay module configured to generate UI overlays for presentation at the client to provide an indication of commands recognized by the application. The interface manager also executes a command module configured to reconcile input generated by the client with the available commands, operations that may be based upon the command data, the input, contextual data, and/or preferences associated with the client.

According to another aspect, the interface manager receives input associated with the client. The interface manager analyzes the command data, contextual data, and/or preferences associated with the client, if available. The interface manager determines, based upon some, all, or none of the available data, one or more commands intended by the input received from the client. The interface manager generates modified input corresponding to the intended command and communicates the modified input to the application. In some instances, if more than one command matches the input, the interface manager interacts with the client to determine which command is desired, and communicates information indicating a selection received from the client to the application. The overlay module can generate an additional overlay to obtain this selection, if desired.

According to various embodiments, the client is configured to execute a traditional operating system, and in other embodiments, the client is configured to execute a web-based operating system. Thus, the client may execute an operating system or other base program that is configured to access web-based or other remotely-executed applications and services to provide specific functionality at the client device. The client therefore may provide various applications and services via a simple operating system or an application comparable to a standard web browser.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for discovering application commands, according to an exemplary embodiment.

FIG. 3 is a flow diagram showing aspects of a method for supporting intelligent user interface interactions, according to an exemplary embodiment.

FIGS. 4A-4C are user interface diagrams showing aspects of exemplary user interfaces for supporting intelligent UI interactions, according to various embodiments.

FIG. 5 is a computer architecture diagram illustrating an exemplary computer hardware and software architecture for a computing system capable of implementing aspects of the embodiments presented herein.

### DETAILED DESCRIPTION

The following detailed description is directed to concepts and technologies for supporting intelligent UI interactions. According to the concepts and technologies described herein, applications can be configured to publish commands, types of commands, and/or command formats that are recognizable and or expected by the applications. Additionally or alternatively, the applications can be analyzed by various devices, nodes, software, and/or other entities to determine the recognizable and/or expected commands. When the application is accessed, data describing the available commands can be presented at a client to indicate the commands available for interfacing with the application. The commands can be presented with information indicating how the user interface and/or input device of the client may be used to execute the available commands, an indication that may take into account contextual information indicating how the device is configured, preferences indicating how the device has been used in the past, preferred interface methods or devices, and the like.

When input is received from the client, the input can be compared to the available commands to determine if the input matches an available command. If so, the command can be implemented. If not, contextual data relating to the client, preferences, and/or other data can be retrieved and analyzed to determine the intent of the client in submitting the input. Thus, information relating to how the device is configured, usage history associated with the device, user preferences, and the like, can be considered to determine the intent, and the intent can be used to identify an intended command and/or to modify the input to match the intended command. The modified input is transmitted to the application, and application execution can continue.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The word “application,” and variants thereof, is used herein to refer to computer-executable files for providing functionality to a user. According to various embodiments, the applications can be executed by a device, for example a computer, smartphone, or the like. Additionally, the computer, smartphone, or other device can execute a web browser or operating system that is configured to access remotely-executed applications and/or services such as web-based and/or other remotely-executed applications, web pages, social networking services, and the like. In some embodiments, the applications, web pages, and/or social networking services are provided by a combination of remote and local execution, for example, by execution of JavaScript, DHTML, AJAX, .ASP, and the like. According to other embodiments, the applications include runtime applications built to access remote or local data. These runtime applications can be built using the SILVERLIGHT family of products from Microsoft Corporation in Redmond, Wash., the AIR and FLASH families of products from Adobe Systems Incorporated of San Jose, Calif., and/or other products and technologies.

For purposes of the specification and claims, the phrase “web application,” and variants thereof, is used to refer to applications that are configured to execute entirely or in-part on web servers and clients. Web applications can include multitier applications that include, but are not limited to, a data tier for storing and/or serving data used by the multitier applications, a logic tier for executing instructions to provide the functionality of the application, and a presentation tier for rendering and displaying the application output and/or interfaces for interacting with the applications. It should be understood that the names of the tiers provided herein are exemplary, and should not be construed as being limiting in any way.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for supporting intelligent UI interactions will be presented.

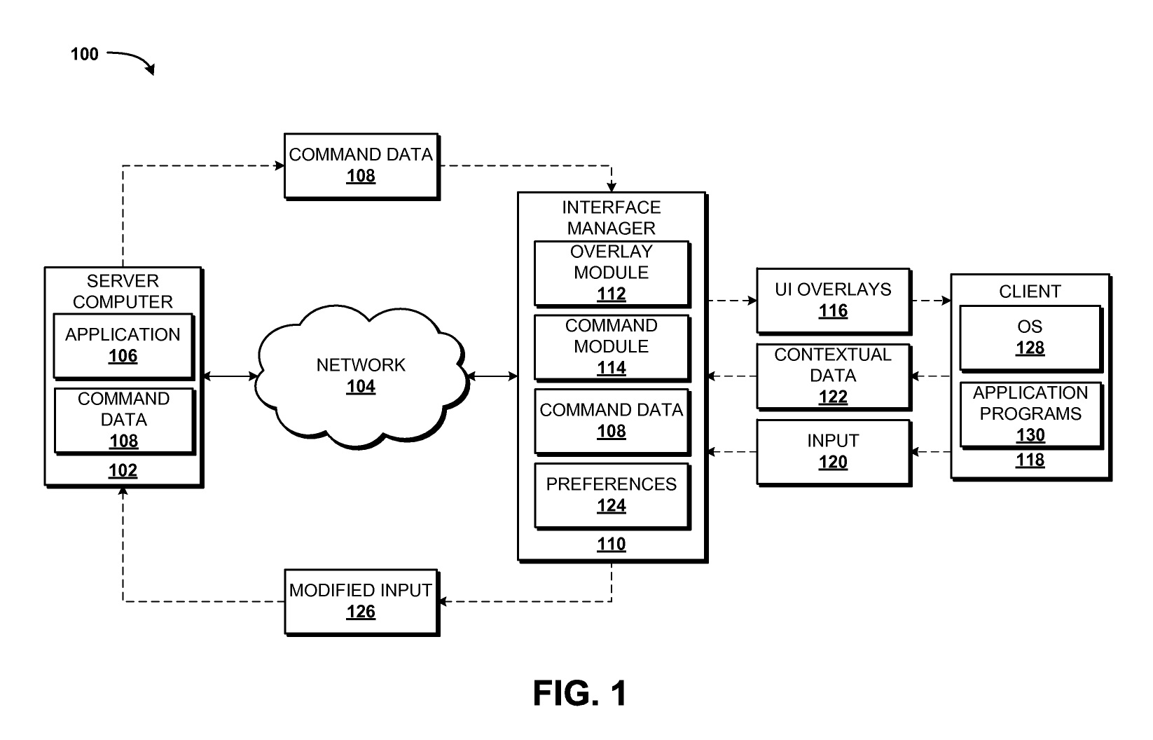

Referring now to FIG. 1, aspects of one operating environment 100 for the various embodiments presented herein will be described. The operating environment 100 shown in FIG. 1 includes a server computer 102 operating on or in communication with a network 104. According to various embodiments, the functionality of the server computer 102 is provided by a web server operating on or in communication with the Internet, though this is not necessarily the case.

The server computer 102 is configured to execute or store an application 106, to host and/or serve web pages, documents, files, multimedia, and/or other content, and/or to host, execute, and/or serve other content, software, and/or services. While the server computer 102 is at times described herein as an application server that executes the application 106 to provide functionality associated with the application 106, it should be understood that this is not necessarily the case. In some embodiments, for example, the server computer 102 executes the application 106 to provide web server functionality, for example by responding to requests for content in response to one or more requests for the content, to execute queries received form devices or entities, and the like.

In other embodiments, the server computer 102 stores the application 106 and allows other devices and/or network nodes to access, download, and/or execute the application 106. It therefore should be understood that the server computer 102 and the application 106 can be used to provide various functionality including, but not limited to, functionality associated with an application server and/or data server. Additionally, though not illustrated in FIG. 1, it should be understood that the server computer 102 can communicate with and/or include databases, memories, and/or other data storage devices to access, modify, execute, and/or store data associated with the server computer 102 and/or the application 106.

According to various embodiments, data relating to the application 106 is generated by execution of the application 106. Similarly, as mentioned above, the server computer 102 can host or serve data corresponding to content such as web pages, services, documents, files, images, multimedia, software, other content, and the like to devices connecting to the server computer 102 via execution of the application 106. In these and other embodiments, data generated, hosted, and/or served by the server computer 102 can be made available, transmitted to, and/or received by one or more devices connecting to the server computer 102. The devices can be configured to display or render the data to display the content and/or output associated with the application 106, to view files such as audio or video files, to view images, to render web pages or other content, and the like.

It should be understood that in the case of data associated with the application 106, the application 106 can be executed at the server computer 102, and output associated with the application 106 can be rendered and displayed at a device remote from the server computer 102. In other embodiments, the application 106 is executed in part by the server computer 102 and in part by devices remote from the server computer 102 such as computers, servers, and the like to provide functionality associated with the application 106. Thus, while the application 106 is illustrated as being hosted by the server computer 102, it should be understood that application components can be simultaneously executed by one or more devices, for example, to provide multitier applications.

According to various implementations, the application 106 and/or other content executed, served, and/or hosted by the server computer 102 responds to or is interacted with based upon commands received from devices or other entities connected to the server computer 102. For example, the application 106 can be configured to respond to particular commands or types of commands. In the case of a web page, for example, the commands can include selection of one or more links to content, the selection of which are interpreted by the application 106 as a command to access the content associated with the link. In the case of web applications such as games, or the like, the commands can include commands to move objects on the screen, to navigate a game environment, keyboard or mouse input such as text input or clicks of mouse buttons, movements of trackballs or stylus devices, voice commands, and/or various other inputs or commands, as is generally understood.

According to various embodiments disclosed herein, data describing commands to which the application 106 responds can be defined by command data 108. In some embodiments, the command data 108 is generated or created by application developers or other entities, and can be stored at the server computer 102. The command data 108 can be used to describe commands that are interpretable by the application 106, descriptions of the commands, actions taken by the application 106 in response to the commands, expected input devices for entering the commands, and the like. The commands data 108 can be generated and stored at the server computer 102 for use, and/or the command data 108 can be based upon discovery of how the application 106 works and/or is controlled and as such may be discovered by devices or other entities in communication with the server computer 102, as is explained in more detail below.

The command data 108 can be searched for and/or indexed by one or more search engines (not illustrated) and/or other entities, and can be used for various purposes. As explained in more detail herein, the command data 108 can be used to present available commands to users or other entities, to inform devices how to communicate with the applications 106, to track user metrics associated with the applications 106 and the like. Commands available for interacting with the application 106 can be presented to a user or other entity. Additionally, or alternatively, capabilities of devices used by the users or other entities to interact with the applications 106 can be considered, as can preferences associated with the users or other entities. These and/or other or additional information can be used to determine what input or types of input can be generated by the devices or other entities and/or to map the command data 108 to one or more commands, gestures, inputs, or other interactions that may be generated by the users or other entities. These and other embodiments will be described in more detail herein.

In some embodiments, the operating environment 100 includes an interface manager 110 operating on or in communication with the network 104. The interface manager 110 is configured to provide the functionality described herein for supporting intelligent UI interactions. In particular, according to various implementations, the interface manager 110 is configured to generate, obtain, store, and/or modify the command data 108, to receive and/or modify input generated at a device or other entity interacting with the application 106, to generate user interfaces for display at the device or other entity for identifying commands available for interacting with the application 106, to store and apply customization and/or personalization to the command data 108 or input generated by the device or other entity, and to provide additional or alternative functionality. In the illustrated embodiment, the interface manager 110 is configured to execute an overlay module 112, a command module 114, and other applications and modules (not illustrated) to provide these and other functionality associated with the interface manager 110.

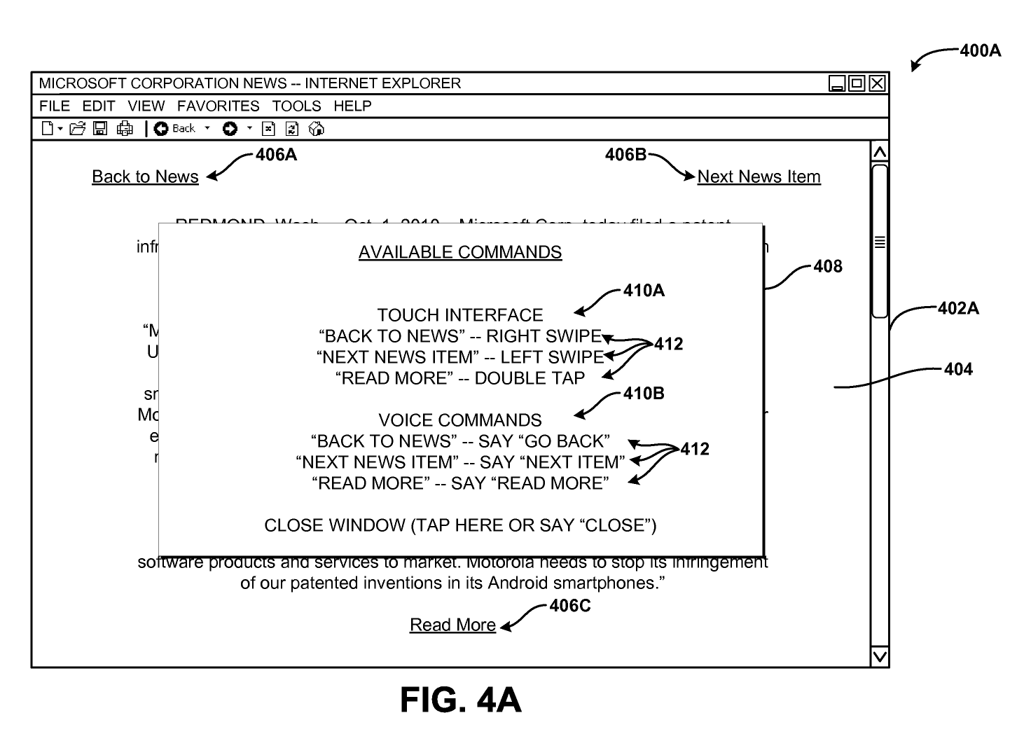

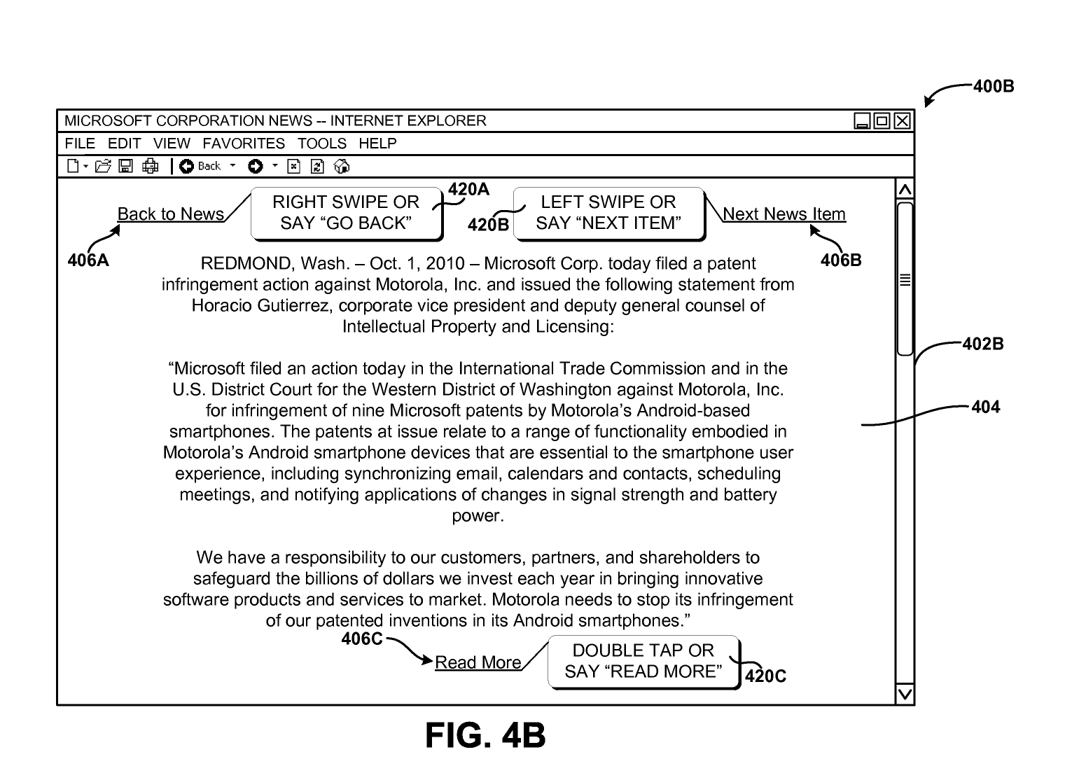

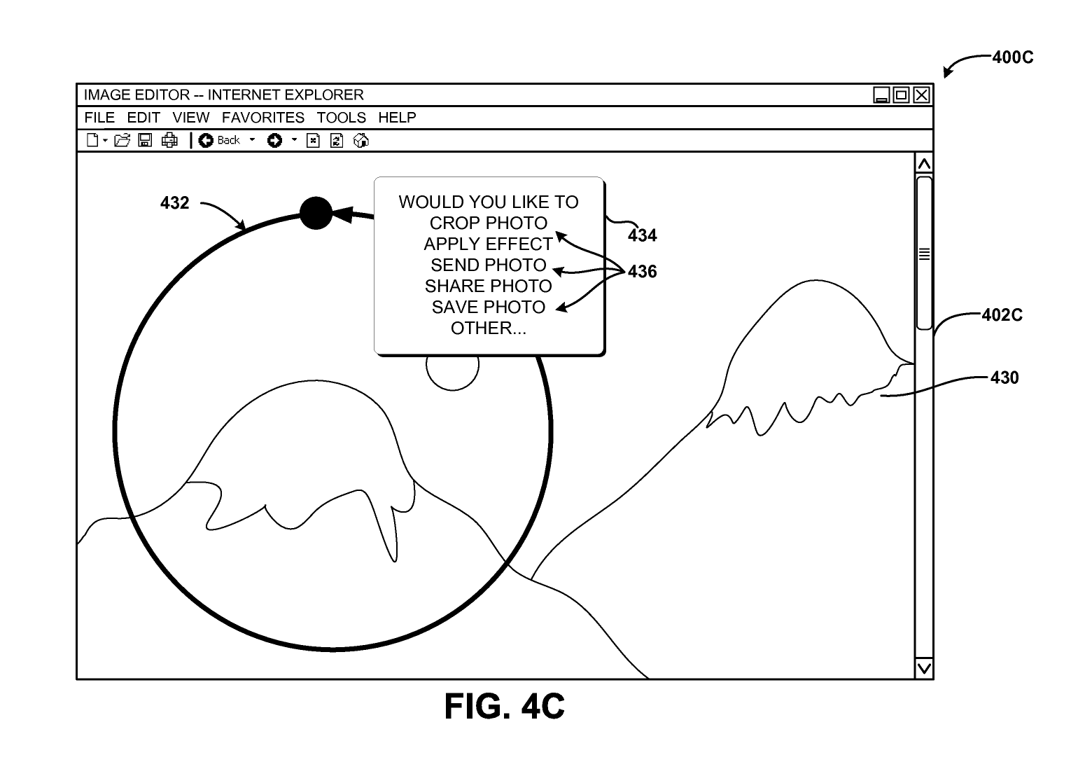

The overlay module 112 can be executed by the interface manager 110 to generate one or more UI overlays 116. As will be described in more detail herein, particularly with reference to FIGS. 4A-4C, the UI overlays 116 can be displayed by a device or other entity such as a client 118 operating on or in communication with the network 104. The UI overlays 116 can be displayed at the client 118 to provide information to a user of the client 118 regarding the commands or types of commands expected by the application 106, among other information. The UI overlays 116 also can provide information regarding one or more inputs 120 that can be generated by the client 118 to interact with the application 106. For example, the inputs 120 may correspond to data that, when submitted to the application 106, will indicate to the application 106 selection of one or more of the commands expected by the application 106. In some embodiments, the data for generating UIs or the UI overlays 116 are generated by the overlay module 112 and provided to the client 118 for rendering and/or display at the client 118.

According to various embodiments, the overlay module 112 is further configured to obtain or analyze contextual data 122 generated by the client 118 and/or discoverable by the interface manager 110. The contextual data 122 can include data describing one or more input devices associated with the client 118, a type or version of software executed by the client 118, capabilities of the client 118, processes executed at the client 118, applications 106 and/or other resources accessed or being accessed by the client 118, and the like. Furthermore, the contextual data 122 can indicate one or more input/output devices or interfaces associated with the client 118, and the like.

In addition to, or instead of, making available or transmitting the contextual data 122, preferences 124 associated with the client 118 can be generated and stored at the interface manager 110 and/or at a data storage device in communication with the interface manager 110. The preferences 124 can be considered alone, or in combination with the contextual data 122, to determine commands, types of commands, and/or interface devices used to generate commands or types of commands at the client 118. Thus, the interface manager 110 can consider the preferences 124 to anticipate how input 120 associated with the client 118 will be generated, what types of gestures, voice commands, movements, actions, and the like, will be generated or sensed at the client 118 when interacting with the application 106, and the like. For example, the interface manager 110 can determine, based at least partially upon the preferences 124, that a user interacting with a drawing program application via the client 118 is likely to interact with the application 106 using a multi-touch interface at the client 118. This example is illustrative, and should not be construed as being limiting in any way.

The command module 114 is configured to reconcile the command data 108 associated with the application 106 with the input 120 generated by the client 118. For example, the command data 108 may specify that the application 106 is configured to interact with mouse movements and/or commands entered at the client 118 via a mouse such as clicks, scroll-wheel movements, and the like. During interactions with the application 106, the client 118 may generate input 120 corresponding to a command entered via a touch screen, a stylus, a multi-touch interface, a voice command, inking, keystrokes, and/or other input mechanisms other than and/or in addition to the mouse commands expected by the application 106. The command module 114 is configured to map the input 120 generated at the client 118 to the expected input based upon the contextual data 122, the preferences 124, and/or determining the intent and/or likely intent associated with the input 120.

In some embodiment, the command module 114 generates modified input 126 and submits the modified input 126 to the application 106. It should be appreciated that the modified input 126 may correspond to a command expected by the application 106. As such, the command module 114 is configured to receive or intercept input 120 generated by the client 118, to modify the input 120 to match input expected by the application 106, and to submit the modified input 126 to the application 106 such that the client 118 can interact with the application 106 via the input 120, even if the input 120 contrasts with commands or input expected by the application 106. It should be appreciated that the above example is illustrative, and that the command module 114 can be configured to reconcile additional or alternative forms of input 120 with input expected by the application 106.

According to some embodiments, the interface manager 110 also is configured to track usage of the application 106 by the client 118, and to machine learn how the client 118 interacts with the application 106. Thus, the interface manager 110 can be configured to generate the preferences 124 based upon interactions between the client 118 and the application 106. In other embodiments, the interface manager 110 is configured to present a machine learning environment to a user via the client 118, whereby a user associated with the client 118 can generate the preferences 124 via guided instructions and/or specific commands and modifications. In embodiments in which the interface manager 110 is configured to support tracking of interactions between the client 118 and the application 106, users can opt-in and/or opt-out of the tracking functionality described herein at any time and/or specify or limit the types of activity tracked by the interface manager 110, if desired, to address perceived security and/or privacy concerns.

According to various embodiments, the functionality of the client 118 is provided by a personal computer (“PC”) such as a desktop, tablet, laptop or netbook computer system. The functionality of the client 118 also can be provided by other types of computing systems including, but not limited to, server computers, handheld computers, embedded computer systems, personal digital assistants, mobile telephones, smart phones, set top boxes (“STBs”), gaming devices, and/or other computing devices. Although not illustrated in FIG. 1, it should be understood that the client 118 can communicate with the interface manager 110 via one or more direct links, indirect links, and/or via the network 104.

The client 118 is configured to execute an operating system 128 and application programs 130. The operating system 128 is a computer program for controlling the operation of the client 118, and the application programs 130 are executable programs configured to execute on top of the operating system 128 to provide various functionality associated with the client 118. According to various embodiments, the operating system 128 executed by the client 118 is a native operating system such as the WINDOWS family of operating systems from Microsoft Corporation of Redmond, Wash. and/or a web-based operating system. Thus, it will be understood that according to various embodiments, the client 118 can be configured or equipped to execute traditional native applications and/or programs at the client-side, and/or to access applications such as the applications 106, which can include remotely-executed applications such as web applications and/or other remote applications. Similarly, it should be understood that the client 118 can execute web-based operating systems and/or applications, as well as native operating systems and/or applications, and that such functionality can, but is not necessarily, accessible via various boot modes.

Additionally, the client 118 can be configured to receive and render data generated by applications such as the application 106. The client 118 also can be configured to receive and render data associated with or generated by the interface manager 110 including, but not limited to, the UI overlays 116. In some embodiments, the client 118 is configured to generate the contextual data 122 and to make the contextual data 122 available to the interface manager 110. Furthermore, the client 118 can generate the input 120, which can correspond to input intended for the application 106, as mentioned above.

The client 118 can be configured to access remotely-executed applications and/or to execute local code such as scripts, local searches, and the like. As such, the client 118 can be configured to access or utilize cloud-based, web-based, and/or other remotely executed applications, and/or to render data generated by the application 106, the interface manager 110, and/or data associated with web pages, services, files, and/or other content.

The application programs 130 can include programs executable by the client 118 for accessing and/or rendering content such as web pages and the like, programs for accessing, executing, and/or rendering data associated with various native and/or web-based applications, and/or programs for accessing, executing, and/or rendering data associated with various services. In other embodiments, the application programs 130 include stand-alone or runtime applications that are configured to access web-based or remote resources and/or applications via public or private application programming interfaces (“APIs”) and/or public or private network connections. Therefore, the application programs 130 can include native and/or web-based applications for providing or rendering data associated with locally-executed and/or remotely-executed applications.

Although not illustrated in FIG. 1, it should be understood that the client 118 can communicate with the server computer 102 and the interface manager 110 via direct links, data pipelines, and/or via one or more networks or network connections such as the network 104. Furthermore, while FIG. 1 illustrates one server computer 102, one network 104, one interface manager 110, and one client 118, it should be understood that the operating environment 100 can include multiple server computers 102, multiple networks 104, multiple interface managers 110, and/or multiple clients 118. Thus, the illustrated embodiments should be understood as being exemplary, and should not be construed as being limiting in any way.

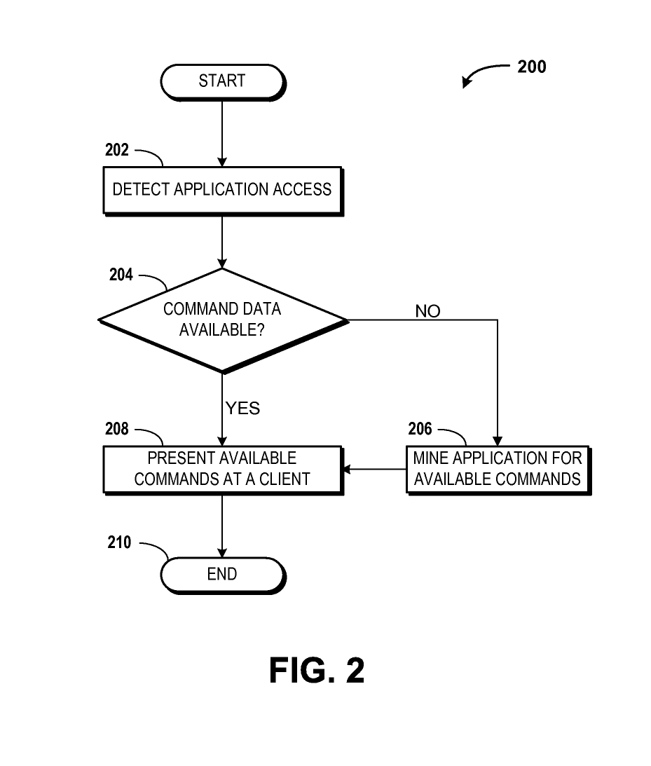

Turning now to FIG. 2, aspects of a method 200 for discovering application commands will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods disclosed herein, and/or substantially equivalent operations, can be performed by execution of computer-readable instructions included on a computer-storage media, as defined above. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof.

For purposes of illustrating and describing the concepts of the present disclosure, the method 200 disclosed herein is described as being performed by the interface manager 110 via execution of one or more modules and/or applications such as the overlay module 112 and/or the command module 114. It should be understood that this embodiment is exemplary, and should not be construed as being limiting in any way. Other devices and/or applications can be configured to discover application commands as disclosed herein without departing from the scope of the claims.

The method begins with operation 202, wherein the interface manager 110 detects access of an application 106 by the client 118. According to various embodiments, the interface manager 110 recognizes access of the application 106 via the tracking functionality of the interface manager 110 described above with reference to FIG. 1. Additionally, or alternatively, the interface manager 110 can be configured to support pass through communications between the client 118 and the application 106. More particularly, the interface manager 110 can interject itself between the client 118 and the application 106 and/or the client 118 can access the application 106 via the interface manager 110. In these and other implementations, output associated with the application 106 can pass through the interface manager 110 before being received and rendered at the client 118, and the input 120 generated at the client 118 can pass through the interface manager 110 before being received at the application 106. It will be appreciated that in some embodiments, the functionality of the interface manager 110 can be provided by execution of one or more application programs 130 at the client 118 and/or another application 106 executed remotely from the client 118 and/or executed at the client 118 in-part and at a remote system in-part. In these and other contemplated embodiments, the interface manager 110 can detect interactions between the client 118 and the application 106.

From operation 202, the method 200 proceeds to operation 204, wherein the interface manager 110 determines if command data 108 relating to the application 106 is available. As explained above with regard to FIG. 1, the command data 108 can be generated by an application developer or other authorized entity such as an administrator associated with the server computer 102 and/or other entities. Additionally, or alternatively, the command data 108 can be determined and/or generated by the interface manager 110 via data mining of the application 106, via tracking of activity between the client 118 and the application 106, and/or via other methods and mechanisms. It should be appreciated that in some embodiments, the command data 108 is determined by the interface manager 110 based, at least partially, upon tags or other indicators published or made available with code corresponding to the application 106. Thus, it should be understood that with respect to operation 202, the interface manager 110 can determine if the command data 108 has been published, indexed, and/or generated by the interface manager 110 at any time before.

If the interface manager 110 determines in operation 204 that the command data 108 is not available, the method 200 proceeds to operation 206, wherein the interface manager 110 analyzes the application 106 to determine commands available for interacting with the application 106. According to various embodiments, the operation 206 includes the interface manager 110 accessing or analyzing executable code corresponding to the application 106 to identify commands that can be recognized by the application 106. In other embodiments, the interface manager 110 analyzes the application 106 and/or information published with the application 106 such as tags or other indicators, to identify commands that can be recognized by the application 106 and/or implemented by the application 106.

According to various embodiments, the command data 108 and/or commands that are supported or understandable by the application 106 are described in specific terms. For example, the command data 108 can include specific commands that are receivable by the application 106. In other embodiments, the command data 108 describes categories or types of commands or input that can be received by the application 106. In yet other embodiments, the command data 108 describes input devices or types of input devices that can be used to generate input recognizable by the application 106. Thus, for example, the command data 108 may indicate that the application 106 is configured to receive alphanumeric input and/or that a specific text string is recognizable by the application 106 to trigger a particular activity. These examples are illustrative and should not be construed as being limiting in any way.

From operation 206, or if the interface manager 110 determines in operation 204 that the command data 108 is available, the method 200 proceeds to operation 208, wherein the interface manager 110 presents available commands at the client 118. As is explained in more detail herein, particularly with reference to FIGS. 4A-4C, the available commands can be presented to the client 118 via UIs, the UI overlays 116, and/or via other methods. Also, it should be understood that the interface manager 110 can transmit data to the client 118 for presentation of the available commands, but otherwise may not be involved in the presentation of the available commands at the client 118. From operation 208, the method 200 proceeds to operation 210. The method 200 ends at operation 210.

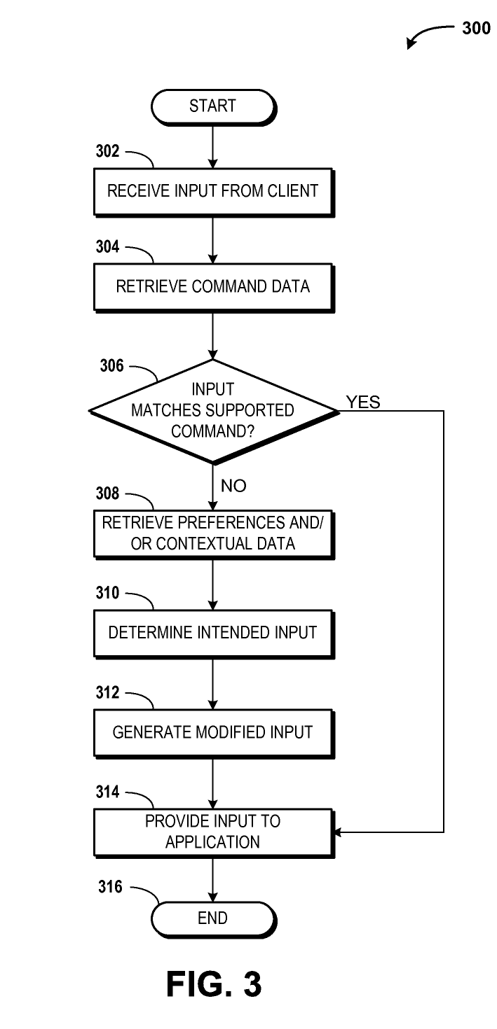

Turning now to FIG. 3, a method 300 for supporting intelligent UI interactions is described in detail, according to an exemplary embodiment. For purposes of illustration, and not limitation, the method 300 is described as being performed by the interface manager 110. It should be understood that this embodiment is exemplary, and should not be construed as being limiting in any way. Other devices and/or applications can be configured to perform the operations disclosed with respect to the method 300 as disclosed herein without departing from the scope of the claims.

The method 300 begins at operation 302, wherein the interface manager 110 receives input 120 from the client 118. The interface manager 110 can be configured to support communications between the client 118 and the application 106. For example, the client 118 may execute the application 106 and/or receive data associated with the application 106 for rendering at the client 118 via the interface manager 110. Similarly, the input 120 generated by the client 118 can be communicated to the application 106 via the interface manager 110. In other embodiments, as explained above, the interface manager 110 is executed by or accessed by the client 118, and therefore can be configured to modify the input 120 before the input 120 is transmitted to the application 106. These examples are illustrative, and other methods for receiving the input 120 from the client 118 are contemplated but are not presented herein for the sake of brevity.

From operation 302, the method 300 proceeds to 304, wherein the input manager 110 retrieves the command data 108 corresponding to the application 106. As explained above with regard to FIGS. 1-2, the interface manager 110 can store the command data 108, obtain the command data from the server computer 102, determine the command data 108 during interactions between the client 118 and the application 106, and/or perform data mining for identifying and/or generating the command data 108.

From operation 304, the method 300 proceeds to operation 306, wherein the interface manager 110 determines if the input 120 received from the client 118 matches a command supported by the application 106. For example, if the command data 108 indicates that the client 118 can interact with the application 106 via entry of a keystroke corresponding to the letter ‘m,’ and the input 120 corresponds to a keystroke ‘m,’ the interface manager 110 can determine that the input 120 received form the client 118 matches a command supported by the application 106. If the command data 108 indicates that the client 118 can interact with the application 106 via entry of keystrokes, but the input 120 corresponds to a multi-touch command, the interface manager 110 can determine that the input 120 does not match a supported command. Thus, it should be understood that the interface manager 110 can analyze not only the specific input 120 received, but also an interface device used to generate and/or submit the input 120. These examples are illustrative, and should not be construed as being limiting in any way.

If the interface manager 110 determines in operation 306 that the input 120 does not match a command supported by the application 106, the method 300 proceeds to operation 308, wherein the input manager 110 retrieves contextual data 122 associated with the client 118 and/or the preferences 124 associated with the client 118. The contextual data 122 can indicate capabilities associated with the client 118, available input devices associated with the client 118, and the like. The preferences 124 can include one or more gestures, movements, actions, or the like, that have been learned by or submitted to the interface manager 110 as corresponding to preferred gestures, movements, actions, or the like for executing particular actions. As noted herein, the preferences 124 can be generated based upon tracked activity between the client 118 and the application 106 and/or by use of customization or personalization procedures such as “wizards,” and the like, for specifying how users wish to interact with the client 118 and/or the application 106. Thus, it will be appreciated that the preferences 124 can be specific to a user of the client 118, specific to the client 118, specific to the application 106, and/or generic to the user, client 118, application 106, and the like.

From operation 308, the method 300 proceeds to operation 310, wherein the input manager 110 determines intended input based upon the received input 120, the command data 108, and the likely intent of a user of the client 118, as determined by the interface manager 110. The likely intent of the user of the client 118 can be determined by the interface manger 110 based upon analysis of the contextual data 122, the input 120, the command data 108, and/or the preferences 124, if desired. In some embodiments, the interface manager 110 determines the likely intent of the user of the client 118 by interfacing with the user, an exemplary embodiment of which is presented below in FIG. 4C.

The intended input can be determined based upon models for mapping particular activities, gestures, movements, and the like, to known commands. For example, some multi-touch gestures may be determined to be intuitive and/or may gain widespread acceptance. A tap, for example, is generally accepted in the touch or multi-touch realms as being roughly equivalent to a mouse click at a point corresponding to the point at which the tap is made. As such, if a tap captured by the interface manager 110 as the input 120, the interface manager 110 may determine that an action corresponding to am mouse click was intended. This example is illustrative and should not be construed as being limiting in any way.

It should be understood that by tracking activity between the client 118 and the application 106, as well as activity between other devices and other applications, the interface manager 110 can develop models of behavior based upon commands entered, responses to prompts to the users for the meaning of their input, oft-repeated commands, and the like. Furthermore, it should be understood that these models can be developed by search engines (not illustrated) and/or other devices, and made available to the interface manager 110, if desired.

From operation 310, the method 300 proceeds to operation 312, wherein the input manager 110 generates modified input 126. The modified input 126 corresponds to input or commands expected by the application 106 but not entered at the client 118, for various reasons. In one contemplated example, the application 106 expects a keystroke command corresponding to a left cursor for a particular action. The input 120 generated by the client 118, however, corresponds to a right swipe or a tap on a portion of a touch interface left of center. Alternatively, the input 120 may include a voice command “go left,” tilting of the client 118 to the left, which may be sensed by an accelerometer or gyroscope associated with the client 118, and the like. In these and other exemplary embodiments, the interface manager 110 may determine that the intended input corresponds to input expected by the application 106, in this example, a left cursor. Thus, the interface manager can generate the modified input 126 corresponding to the expected input. In the above example, the interface manager 110 generates a left cursor keystroke and submits the modified input 126 to the application 106.

From operation 312, or if the interface manager 110 determines in operation 306 that the input matches a supported command, the method 300 proceeds to operation 314, wherein the interface manager 110 provides the input to the application 106. As explained above, the input provided to the application 106 can include the input 120 itself, if the input 120 matches a supported command, or the modified input 126, if the input 120 does not match a supported command. From operation 314, the method 300 proceeds to operation 316. The method 300 ends at operation 316.

Turning now to FIG. 4A, a user interface diagram showing aspects of a user interface (UI) for presenting available commands at the client 118 in one embodiment will be described. In particular, FIG. 4A shows a screen display 400A generated by one or more of the operating system 128 and/or the application programs 130 executed by the client 118 according to one particular implementation presented herein. It should be appreciated that the UI diagram illustrated in FIG. 4A is exemplary. Furthermore, it should be understood that data corresponding to the UI diagram illustrated in FIG. 4A can be generated by the interface manager 110, made available to or transmitted to the client 118, and rendered by the client 118, though this is not necessarily the case.

In the illustrated embodiment, the screen display 400A includes an application window 402A. In some implementations, the application window 402A is displayed on top of or behind other information (not illustrated) displayed on the screen display 400A. Additionally, or alternatively, the application window 402A can fill the screen display 400A and/or can be sized to fit a desired portion or percentage of the screen display 400A. It should be understood that the illustrated layout, proportions, and contents of the illustrated application window 402A are exemplary, and should not be construed as being limiting in any way.

The exemplary application window 402A corresponds to an application window for a web browser, though this example is merely illustrative. It should be understood that the application window 402A can correspond to an application window for any application, including native applications such as the application programs 130, web applications, the application 106, and/or an interface displayed or rendered by the operating system 128. In the illustrated embodiment, the application window 402A is displaying web content 404, and the web content includes hyperlinks 406A-C (hereinafter referred to collectively or generically as “links 406”).

The links 406 can correspond to computer executable code, the execution of which causes the client 118 to access a resource referred to by the links 406, as is generally known. Thus, the links 406 may correspond to one or more commands as described herein. As such, it will be appreciated that the concepts and technologies described herein with reference to FIG. 4A can be applied to any number of commands displayed via execution of a variety of native, web-based, and/or hybrid applications. The links 406 include a link 406A for returning to a news page, a link 406B for viewing a next news item, and a link 406C for reading more of a story displayed as the content 404. It should be understood that these links 406 are exemplary and should not be construed as being limiting in any way.

The application window 402A also is displaying an available commands window 408, which can be presented in a variety of manners. In the illustrated embodiment, the available commands window 408 is displayed as an opaque window that is superimposed in “front” of the content 404. In other contemplated embodiments, the available commands window 408 is docked to a side, the top, or the front of the application window 402A, placed into a tool bar or status bar, placed into a menu, and the like. In yet other contemplated embodiments, the application window 402A is superimposed in “front” of the content 404, but is only partially opaque, such that the content 404 and the available commands window 408 are simultaneously visible. In still further contemplated embodiments, the available commands window 408 is hidden until a UI control for accessing the available commands window 408, a voice command for accessing the available commands window 408, or other commands for accessing the available commands window 408 is received by the client 118.

The available commands window 408 can be configured to display commands that are usable in conjunction with the screen display 400A. In some embodiments, the available commands window 408 displays commands for various input devices that are detected by the interface manager 110. As explained above, the interface manager 110 can detect available input devices, for example, by accessing the contextual data 122 associated with and/or generated by the client 118. In the illustrated implementation, the available commands window 408 is displaying a touch interface list of commands 410A, which lists three commands 412 available for interacting with the content 404 or links 406 via a touch interface. The available commands window 408 also includes a voice commands list of commands 410B, which lists three commands 412 available for interfacing with the content 404 via voice commands. It should be understood that these lists are exemplary, and that additional or alternative lists can be displayed depending upon capabilities associated with the client 118, the contextual data 122, the preferences 124 and/or the command data 108.

The available commands window 408 is generated by the interface manager 110 to inform a user of the client 118 of commands that are available to the user, based upon capabilities of the client 118, preferences of the user, and/or input sought by the application 106. It should be understood that this embodiment is exemplary, and that other methods of communicating this and/or other command-based information to the user are possible and are contemplated. From a review of the information displayed in the available commands window 408, a user at the client 118 can determine how to navigate the content 404 via a touch interface and/or voice commands, some, all, or none of which may be supported by the application 106 as authored. In some embodiments, the links 406 are authored and intended for navigation via a mouse or other traditional input device. As explained above with reference to FIGS. 1-3, the interface manager 110 can recognize and interpret alternative commands entered via one or more interfaces, and generate information such as the information displayed in the available commands window 408 for communicating to a user what commands are available and/or what gestures, speech commands, movements, and the like, can be invoked for executing the available commands.

Turning now to FIG. 4B, a user interface diagram showing aspects of a user interface (UI) for presenting available commands at the client 118 in another embodiment will be described. In particular, FIG. 4B shows a screen display 400B generated by one or more of the operating system 128 and/or the application programs 130 executed by the client 118 according to one particular implementation presented herein. It should be appreciated that the UI diagram illustrated in FIG. 4B is exemplary. As explained above with regard to FIG. 4A, it should be understood that data corresponding to the UI diagram illustrated in FIG. 4B can be generated by the interface manager 110, made available to or transmitted to the client 118, and rendered by the client 118, though this is not necessarily the case.

As explained above with regard to the screen display 400A in FIG. 4A, the screen display 400B includes an application window 402B that can be sized according to various sizes and layouts, and is not limited to the illustrated content, size, or configuration. The application window 402B includes the content 404 displayed in the application window 402A, as well as the links 406 displayed in the application window 402A, though this is not necessarily the case. In FIG. 4B, the available commands associated with the content 404 are displayed via three available commands callouts 420A-C (hereinafter referred to collectively or generically as available commands callouts 420). It will be appreciated that the contents of the available commands callouts 420 can be substantially similar to the contents of the available commands window 408 illustrated in FIG. 4A, though the available commands callouts can be displayed at, near, or in connection with the links 406. It should be appreciated that in some embodiments, an available commands window 408 is displayed when an application 106 or other content is accessed, and that the available commands callouts 420 can be displayed or persisted after the available commands window 408 is closed or disappears after a display time, in response to mouse hovers, and the like. The illustrated embodiment is exemplary and should not be construed as being limiting in any way.

Referring now to FIG. 4C, a user interface diagram showing aspects of a user interface (UI) for supporting intelligent UI interactions in yet another embodiment will be described. In particular, FIG. 4C shows a screen display 400C generated by one or more of the operating system 128 and/or the application programs 130 executed by the client 118 according to one particular implementation presented herein. It should be appreciated that the UI diagram illustrated in FIG. 4B is exemplary. As explained above with regard to FIGS. 4A-4C, the UI diagram illustrated in FIG. 4C can be generated by the interface manager 110, made available to or transmitted to the client 118, and rendered by the client 118, though this is not necessarily the case.

In the embodiment illustrated in FIG. 4C, the screen display 400C includes an application window 402C that can be sized according to various sizes and layouts, and is not limited to the illustrated content, size, or configuration. The application window 402C includes content 430. In the illustrated embodiment, the content 430 corresponds to output generated via execution of the application 106, wherein the application 106 provides a photo viewing and editing application. In the illustrated embodiment, a drawing path 432 is illustrated. It should be understood that the drawing path 432 may or may not be displayed on the screen display 400C, depending upon settings associated with the application 106, settings associated with the client 118, and/or other considerations. The drawing path 432 corresponds, in various embodiments, to a motion made with an interface object on a touch or multi-touch screen. For example, the drawing path 432 may correspond to a stylus path, a finger path, or the like.

In response to the drawing of the drawing path 432, the interface manager 110 can determine if the input 120 corresponding to the drawing of the drawings path 432 corresponds to a command supported by the application 120, as explained above with reference to operation 306 of FIG. 3. According to various embodiments, the drawing path 432 corresponds to a command supported by the application 120, or corresponds to a command determined by the interface manager 110 based upon the contextual data 122 and/or the preferences 124, for example. In other embodiments, the drawing path 432 corresponds to two or more commands and/or is interpreted by the interface manager 110 as indicating that the user wants to access one or more commands with respect to a region bound by the drawing path 432. Additionally, or alternatively, the drawing path 432 and/or alternative drawing paths can indicate that the user wishes to submit a command to the application 106. In these and other embodiments, the interface manager 110 can be configured to display a UI overlay 116 for displaying an available commands callout 434 in response to the drawing of the drawing path 432.

The available commands callout 434 can be configured to display a number of commands 436 that may be invoked with respect to the region bound by the drawing path 432 and/or with respect to the content 430. In the illustrated embodiment, the available commands callout 434 includes a combination of commands 436 that may be invoked with respect to the region bound by the drawing path 432 and with respect to the content 430. In some embodiments, the displayed commands 436 may be numbered, and the user can select an option by speaking a selection, pressing a number key on a keyboard, and the like. In other embodiments, the user taps on the desired command. Other embodiments are possible, and are contemplated.

According to various embodiments of the concepts and technologies disclosed herein, the client 118 can include a number of sensors, input devices, and/or other mechanisms for generating the input 120. For example, in some embodiments the client 118 is configured to generate the input 120 using one or more of a mouse, a trackball, a stylus, a keyboard, a touch screen, a multi-touch screen, a touch or multi-touch device, an inking system, microphones, cameras, orientation sensors, movement and acceleration sensors, and the like. Thus, it should be understood that the input 120 can be generated via the client 118 using manual movements, voice commands, gestures in free space, altering the orientation of an input device, and the like. According to some embodiments, the orientation sensing is accomplished using one or more accelerometers, magnetometers, gyroscopes, other sensors, and the like.

According to various embodiments, the interface manager 110 is configured to analyze the contextual data 122 and/or the preferences 124 to identify what is anticipated as being the best input mode for the client 118. For example, the interface manager 110 may determine that the client 118 is configured to support touch commands and voice commands. Similarly, the interface manager 110 may determine that a location associated with the client 118, an audio input associated with the client 118, and/or other data that may be obtained by way of the contextual data 122, indicates that the voice commands may be impractical. For example, the interface manager 110 may determine that the ambient noise level in the vicinity of the client 118 is above a defined threshold above which discerning voice commands becomes difficult. In these and other contemplated circumstances, the interface manger 110 can determine that a particular supported input mode, in this example voice commands, may be impractical, and can identify another input mode such as touch or multi-touch commands as being preferable, under the circumstances. This example is illustrative, and should not be construed as being limiting in any way.

It should be understood that the concepts and technologies disclosed herein can be configured to support various combinations of input modes, as illustrated with regard to FIGS. 4A-4C. Thus, for example, the interface manager 110 can be configured to map voice commands, touch commands, mouse or keyboard input, and/or other input 120 to input expected by the application 106. As such, the interface manager 110 can be configured to allow users to interact with the client 118 in a variety of manners, which may allow the users to interact with the client 118 in a manner that is intuitive from the perspective of the user. As such, the user may not be limited to using only a few narrowly define commands and instead can use a variety of input 120 generated via a variety of input devices.

In some cases, touch and multi-touch movements, free space gestures, orientation, and/or other movements corresponding to a command may begin with movements that are similar to or identical to a number of other movements. For example, a tap, double tap, and triple tap on a touch interface all begin with a tap. As such, the interface manager 110 can be configured to recognize that input 120 may correspond to a number of commands, may therefore wait for completion of the commands, and/or may present commands that begin with the same movements or input to a user based upon the initial movements, if desired. More particularly, the interface manager 110 can impose a wait period or pause when input 120 is received to allow time for the input 120 to be completed before attempting to reconcile the input 120 with commands expected by the application 106. Other forms of error correction and/or prevention are contemplated, but are not described herein in detail.

As explained above, the interface manager 110 can be configured to monitor usage of an application 106 over time with respect to the client 118 and/or with respect to a number of devices. As such, the interface manager 110 can be configured to determine commands that are popular or frequently used with respect to an application over time and/or with respect to one or more users. The interface manager 110 can take this information into account when presenting the available commands to the client 110 and/or report this usage to authorized parties associated with the application 106.

With respect to reporting to authorized entities associated with the applications 106, the interface manager 110 can report not only trends regarding input during interactions with the application 106, but also input 120 sensed by the interface manager 110, wherein the input 120 did not correspond to a supported command. As such, the interface manager 110 can provide feedback to application developers, for example, who can add code to support these and/or other commands. The feedback also can indicate that users often attempt to enter a particular command that is not supported, information that may be used by the application developers to add support for the particular command. These examples are illustrative of possible uses for the feedback and should not be construed as being limiting in any way.

In some embodiments, the interface manager 110 is configured to provide one or more wizards to application developers for use in developing the application 106. The wizards can support generation of the command data 108 in a format that is readily recognizable by the interface manager 110 and/or a search engine (not illustrated). The wizards also can be used to provide application developers with up-to-date information regarding the most popular input devices such that the application 106 can be authored to support these popular devices.

In some embodiments, the interface manager 110 tracks and reports activity to a search engine (not illustrated) for ranking and/or advertising purposes. In one contemplated embodiment, applications 106 are ranked based upon objective and/or subjective determinations relating to how intuitive the applications 106 are. In one embodiment, such a determination may be made by tracking a number corresponding to a number of times users access the application 106 and enter input 120 that corresponds to one or more commands expected by the application 106, and/or tracking a number corresponding to a number of times users access the application 106 and enter input 120 that does not correspond to input expected by the application 106. It will be appreciated that these numbers can indicate how intuitive the application 106 is from users' standpoints, and therefore can be an indicator of anticipated popularity and/or quality.

In some embodiments, the interface manager 110 is configured to map commands from one application to a second application. Thus, for example, a user my indicate that commands or gestures associated with a first application are to be applied to the second application. This indication may be stored as the preferences 124 and applied to the second application when the client 118 accesses the second application, if desired. These embodiments are exemplary, and should not be construed as being limiting in any way.

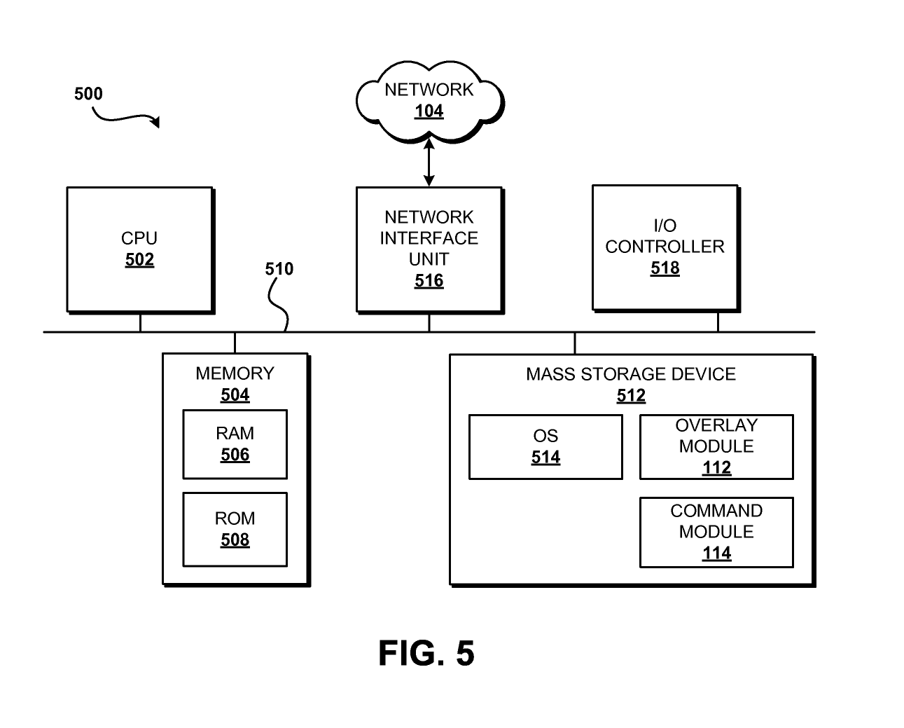

FIG. 5 illustrates an exemplary computer architecture 500 for a device capable of executing the software components described herein for supporting intelligent UI interactions. Thus, the computer architecture 500 illustrated in FIG. 5 illustrates an architecture for a server computer, mobile phone, a PDA, a smart phone, a server computer, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 514, the overlay module 112 and the command module 114. Although not shown in FIG. 5, the mass storage device 512 also can be configured to store the command data 108 and/or the preferences 124, if desired.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media that can be accessed by the computer architecture 500.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes of this specification and the claims, the phrase “computer-readable storage medium” and variations thereof, does not include waves, signals, and/or other transitory and/or intangible communication media.

According to various embodiments, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems, for example, the client device 118. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

Based on the foregoing, it should be appreciated that technologies for supporting intelligent UI interactions have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for supporting intelligent user interface interactions, the computer-implemented method comprising performing computer-implemented operations for:
receiving input from a client, the input being associated with a web application being accessed by the client via a user interface;
retrieving command data associated with the web application, the command data indicating one or more commands supported by the web application;
determining if the input corresponds to the one or more commands supported by the web application; and
in response to determining that the input does not correspond to the one or more commands,
determining an input intended by the client, and
generating modified input corresponding to one or more of the commands supported by the web application.

2. The method of claim 1, further comprising in response to determining that the input does not correspond to the one or more commands, retrieving contextual data associated with the client, the contextual data indicating one or more capabilities of the client.

3. The method of claim 2, wherein the one or more capabilities of the client comprise an input device supported by the client.

4. The method of claim 1, wherein the command data is obtained from a server computer hosting the web application, the command data being generated by an authorized entity associated with the web application and hosted by the server computer.

5. The method of claim 1, wherein generating the command data is generated by the interface manager upon determining that the command data is not hosted by the server computer, wherein generating the command data comprises mining the web application to determine input expected by the web application.

6. The method of claim 2, further comprising in response to determining that the input does not correspond to the one or more commands, retrieving preferences associated with a user of the client.

7. The method of claim 6, wherein determining the input intended by the client comprises analyzing the command data, the contextual data, and the preferences to interpret the input.

8. The method of claim 6, wherein the preferences comprise data tracked during interactions between the client and the web application.

9. The method of claim 6, wherein the preferences comprise data generated during interactions between the client and the interface manager.

10. The method of claim 1, wherein the web application comprises computer executable code configured for access via a computer executing a web-based operating system.

11. The method of claim 1, wherein determining if the input corresponds to the one or more commands comprises
generating a user interface overlay comprising an indication of one or more commands corresponding to the received input and one or more user interface controls corresponding to the one or more commands, and
receiving selection of one or more of the user interface controls corresponding to one or more of the one or more commands.

12. The method of claim 11, wherein generating the modified input comprises generating the one or more commands corresponding to the selected user interface control, and submitting the one or more commands to the web application.

13. The method of claim 12, further comprising:
tracking interactions between the client and the web application; and
reporting the interactions to at least one authorized entity associated with the web application.

14. The method of claim 1, further comprising generating a user interface when the web application is accessed, the user interface being configured to display the one or more commands supported by the web application and an indication of input at the client that corresponds to the one or more commands.

15. A computer-implemented method for supporting intelligent user interface interactions, the computer-implemented method comprising performing computer-implemented operations for:
accessing a web application via a client configured to execute a web-based operating system;
retrieving command data associated with the web application, the command data indicating one or more commands supported by the web application;
presenting a user interface at the client, the user interface being configured to display the one or more commands supported by the web application and an indication of input at the client that corresponds to the one or more commands;
receiving input at the client;
determining if the input corresponds to the one or more commands supported by the web application; and
in response to determining that the input does not correspond to the one or more commands, determining an intended input and generating modified input corresponding to one or more of the commands supported by the web application.

16. The method of claim 15, wherein the command data comprises data indicating one or more user interfaces for generating the one or more commands, and wherein the input received is generated by a user interface not indicated by the command data.

17. The method of claim 15, wherein determining if the input corresponds to the one or more commands comprises generating a user interface overlay comprising an indication of one or more commands corresponding to the received input and one or more user interface controls corresponding to the one or more commands, and receiving selection of one or more of the user interface controls.

18. The method of claim 12, further comprising:
tracking interactions between the client and the web application; and
generating preferences based, at least partially, upon the interactions tracked.

19. A computer-readable storage medium having computer readable instructions stored thereupon that, when executed by a computer, cause the computer to:
retrieve command data associated with a web application hosted by a server computer, the command data indicating one or more commands supported by the web application;
detect an interaction between a client and the web application;
generate a user interface overlay for display at the client, the user interface overlay being configured to display the one or more commands supported by the web application and an indication of input at the client that corresponds to the one or more commands;
receive input from a client, the input being associated with a web application being accessed by the client via a user interface;
determine if the input corresponds to the one or more commands supported by the web application; and
in response to determining that the input does not correspond to the one or more commands,
retrieve contextual data associated with the client, the contextual data indicating one or more capabilities of the client,
retrieve preferences associated with the client,
determine an input intended by the client based, at least partially, upon the input, the command data, the preferences, and the contextual data, and
generate modified input corresponding to one or more of the commands supported by the web application.

20. The computer-readable storage medium of claim 19, wherein determining if the input corresponds to the one or more commands comprises
generating a second user interface overlay comprising an indication of one or more commands corresponding to the received input and one or more user interface controls corresponding to the one or more commands, and
receiving selection of one or more of the user interface controls corresponding to one or more of the one or more commands.
